(19) United States
(12) Patent Application Publication
(10) Pub. No.: US 2021/0251264 A1
(43) Pub. Date: Aug. 19, 2021

(54) A PROCESS FOR MICROBIAL STABILIZATION AND PROCESSING OF BREWERS SPENT GRAIN, MICROBIOLOGICALLY STABILIZED BREWERS SPENT GRAIN POWDER AND USE THEREOF

(71) Applicant: ANHEUSER-BUSCH INBEV S.A., Belgium (BE)

(72) Inventors: Jorge GIL-MARTINEZ, Leuven (BE); Elke ARENDT, Cork City (IE); Steffen MUENCH, Leuven (BE)

(21) Appl. No.: 17/271,172

(22) PCT Filed: Aug. 23, 2019
(86) PCT No.: PCT/EP2019/072584

§ 371 Date: Feb. 24, 2021

(30) Foreign Application Priority Data
Aug. 24, 2018 (BE) 2018/5588

(51) Int. Cl. A23L 7/25; C12F 3/06; A23L 3/46; A23B 9/08; A21D 2/36; A23G 3/48; A23L 2/52

(52) U.S. Cl. CPC A23L 7/25; C12F 3/06; A23L 3/46; A23V 2002/00; A21D 2/368; A23G 3/48; A23L 2/52; A23B 9/08

(57) ABSTRACT

A process processing fresh brewer's spent grains (BSG), the process comprising the steps of: Producing a mash comprising barley malt; Separating the mash from BSG; Collecting the BSG; Microbiologically stabilizing the collected BSG; drying said BSG; and powdering said dried BSG.

### FIELD OF THE INVENTION

The present invention concerns a process for treating brewers' spent grains (BSG) obtained from the brewing process such that the growth of microbes in said grains and subsequent production of microbial toxins are kept below levels herewith specified (microbial stabilization) and that the processed BSG can be easily transported and processed as a food-ingredient in for example given bakery products. This invention covers a method for acidification of BSG with one or a combination of acids, or organic acids, or food-grade organic acids to achieve microbial stability of BSG. The present invention further concerns microbiologically stable BSG (MS-BSG) powder obtained from said process. The invention further concerns the stability of BSG for longer time periods than currently possible, the consequential expansion in the range of applications for MS-BSG and the necessary increase in value of MS-BSG originating from said applications. The invention further concerns the use of microbiologically stable brewers' spent grain (MS-BSG) powder for the production of human food and/or food-grade ingredient and/or for the production of a food-grade beverage ingredient.

### BACKGROUND TO THE INVENTION

Brewers' spent grain (BSG) is the most abundant co-product generated in the beer-brewing process, making up to 85% of total waste products. This material consists of the barley grain husks obtained as solid portion after wort filtration. Since BSG is rich in carbohydrates and proteins, the main use to date for the utilization of this product has been as animal feed.

Beyond the conventional use as cattle feed, several other applications have been proposed for BSG (reviewed by Mussatto et al., 2006¹ and Xiros and Christakopoulos, 2012²): energy production in the form of direct combustion, reduction to BSG charcoal or for biogas production; as a raw material for brick building and paper making; in biotechnology applications such as enzyme production, and propagation of microorganisms and; fractionation and enrichment of high-value components, such as proteins or phenolic compounds.

However, the nutritional value of BSG also makes it an interesting candidate for human foodstuff or ingredient. Several applications of BSG as food or food ingredient have been described (reviewed by Mussatto et. Al, 2006¹ and Lynch et al., 2016³). Brewers' spent grain has been used as an ingredient for baking goods such as bread, cookies, bread sticks, baked snacks and also sausages and as a beverage additive. A number of health benefits are associated with including BSG in a diet, including reduction of postprandial blood glucose levels, lowering of cholesterol, prebiotic, immunomodulatory and antioxidant activities.

Microbial stability is a major concern in the use of BSG for either animal or human consumption. The availability of water, sugars and proteins make BSG an attractive substrate for microbes, which can quickly colonize it and compromise its integrity for its subsequent use as food. There are problems associated with microbial spoilage of BSG: first, the possibility of growth of pathogenic microbes, next, the depletion of nutrients from BSG by spoilage microorganisms and, last, the production of toxic compounds by fungi. The latter is of concern, particularly the production of stable mycotoxins.

The very short stability of wet BSG has been identified as an obstacle for its use as animal feed, human food or human food ingredient. Without an effective preservation method, BSG becomes quickly infected by microbes. This compromises the nutritional integrity and general food safety of BSG.

Current methods for preventing spoilage of BSG include (reviewed by Mussato et al., 2006):
Drying in a rotary-drum drier or in an oven. The former consumes large amounts of energy while the latter can introduce unpleasant aromas and flavors to BSG derived from chemical reactions at high drying temperatures. An alternative experimental method of drying involves the use of superheated steam⁵.
Freezing. Storage of large amounts of frozen BSG is not practical or economical. Additionally, thawed BSG can have a lower arabinose content than fresh BSG, possibly due to microbial growth during thawing⁶.
Pressing and vacuum packing. Good stability of BSG was achieved by EI-Shafey et al. (2004)⁷ using a membrane filter press coupled with vacuum drying. The resulting BSG had 20% moisture which was reduced to 10% after storing in open air. No microbial growth was observed up to 6 months after treatment⁷.
Preservation of BSG using organic acids was investigated by Al Hadithi et al. (1985⁸, as quoted by Mussato et al., 2006). They found that organic acids prevented spoilage and preserved the nutritional value of BSG for long periods of time.

Acidification is a traditional means of preserving food. Food can be acidified either by direct addition of acid (e.g. pickling with vinegar), by microbial fermentation of food by lactic or acetic acid bacteria species (e.g. sauerkraut, kimchi) or a combination of both. The low pH (<4.1) and presence of organic acids inhibits the growth of most harmful bacteria and fungi. Moreover, lactic and acetic acid are generally perceived as pleasant in food at the right concentrations and are considered harmless to human health.

Brewing manufacturing process are in place to keep the final product, beer, but not its co-products, microbiologically stable. Brewers' spent grain is not microbiologically compromised out of the filter or lauter tun. The temperature conditions during mashing and filtering are up to 75° C. Out of the filter, BSG has relatively low counts of microbes, with the exception of thermophilic bacteria, and can be considered microbiologically stable⁴. However, as the grains cool down, and because the grains are treated as a waste product without any food safety concerns, mesophilic bacteria and fungi are able to grow on them. After one day of storage at 25° C., the colony count of bacteria (aerobic and anaerobic) and fungi increases from less than 100 colony forming units (CFU) per gram of BSG to 10⁵ and 10⁸ CFU/gram, respectively. After two days, all microbes are found in the 10⁸ CFU/gram order of magnitude.

Mycotoxins are a type of compound produced by fungi which grow on cereal crops. They can be toxic and deadly for humans and animals if consumed in high doses. Because of this, they are of great concern to the cereal food industry, and to the brewing industry, and limits have been set for the maximum levels allowed in food. Fungal contamination of BSG can result in the production of mycotoxins, which is an irreversible process, i.e. once the level of mycotoxins in BSG is above a set limit, it is considered unsafe for consumption.

Considering the time frames on which microbial growth and spoilage occurs after BSG has left the filter/lauter tun, the opportunities for its use as animal or human food ingredient are limited. Within hours, BSG microbial and/or mycotoxin levels can be above the recommended levels for human consumption.

The use of BSG as human food or food ingredient requires that BSG be available at its freshest state and yet in an easy to transport and processable state, before any significant microbial growth and/or mycotoxin production compromises its integrity. For any food production process, this poses an incredibly difficult operational barrier. Therefore, there remains a need for keeping the integrity of BSG for use as human food or food ingredient.

### SUMMARY OF THE INVENTION

The present invention concerns a process for stabilizing fresh brewer's spent grains (BSG) microbiologically, the process comprising the steps of:
Producing a mash comprising barley malt;
Separating the mash from BSG;
Collecting the BSG;
Microbiologically stabilizing the collected BSG;
Drying said BSG; and
Powdering said dried BSG.

The microbiological stabilization comprising acidifying the BSG to a pH of 4 or lower; characterized in that the BSG:
is acidified prior to reaching mycotoxin levels higher than 3 μg/kg Ochratoxin A (OTA), higher than 750 μg/kg deoxynivalenol (DON), higher than 20 μg/kg nivalenol (NIV), and higher than 75 μg/kg zearalenone (ZEA) and/or
having a colony count of not higher not higher than 10³ CFU/g MS-BSG total aerobic bacteria and; not higher than 10³ CFU/g MS-BSG fungi and; not higher than 10³ CFU/g MS-BSG yeast and; not higher than 10³ CFU/g MS-BSG mesophilic aerobic bacteria and; not higher than 10³ CFU/g MS-BSG total anaerobic bacteria, after one week of storage at 25° C.

More specifically, the use of food-grade organic acids makes the resulting BSG microbiologically stable and safe for human consumption. Even more specifically, the use of a combination of 0.4% lactic acid and 0.4% acetic acid results in a microbiologically stable product, safe for human consumption with acceptable organoleptic characteristics.

An objective of this invention is to render BSG microbiologically stable over longer periods of time than currently possible and readily transportable and processable as a food ingredient. As a result, the range of applications of MS-BSG is much broader than that of untreated BSG, rendering MS-BSG into a much more valuable raw material than untreated BSG.

Thus, a further aspect of this invention concerns MS-BSG powder and uses thereof. One application of MS-BSG powder is as as part of human diet, for example as, but not limited to, an ingredient in flours, a baking-product additive or a food fortification ingredient. A further application of food-grade MS-BSG powder is as an ingredient material for a beverage.

### Definitions

BSG consists of the seed coat-pericarp-husk layers that covered the original barley grain. The starch content is usually low, and the composition of BSG mainly contains fibers, which are non-starch polysaccharides (NSP, ˜38%; hemicellulose in the form of arabinoxylans (AX) and cellulose) and significant quantities of proteins (˜19%), lignin (˜15%), bound phenolics (10%), lipids (˜10%) and ash (5%)⁴. Therefore, BSG is basically a lignocellulosic material. This high fiber and protein content makes BSG an interesting raw material for food applications.

As it is released from the wort filter or lauter tun, BSG can contain anywhere from 70 to 85% water. The high level of water and presence of nutrients make BSG a good substrate for bacterial and fungal growth. In fact, fresh BSG is quickly colonized by different types of bacterial and fungal species if no measures are taken against this. After two days of incubation of BSG at 25° C., there is an increase of total bacteria, mesophilic bacteria, anaerobic bacteria and fungi to 10⁷-10⁸ CFU/g of BSG. Storage of BSG at 25 and 35° C. is also associated with a decrease in the nutritional value of BSG: there is a decrease in total protein, soluble sugars and total dry mass of the BSG⁹.

Wang et al. (2014)⁹ and the authors here have observed a significant increase in both yeast and mold in BSG after 2 days storage at 25° C. In both cases, mold colony counts are as high as 10⁶ after 1 day and 10⁸ after 2 days⁹ (and Lynch, unpublished). There is evidence that portion of the mold community in stored BSG is composed of mycotoxin-producing molds, such as Penicillum and Fusarium species¹⁰.

Mycotoxins are compounds produced by fungi that infect food crops. They are particularly prevalent in cereal crops, such as in barley or wheat used for brewing. Different types of mycotoxins have various effects on the health of animals that are fed the contaminated crop. Mycotoxins are very stable molecules, resisting cold or heat treatments, and even animal digestion, which means they can enter human food chain through contaminated animals.

The main fungi affecting barley are those of Fusarium genus^{11,12.} Fusarium species produce a variety of toxins, including zearalenone (ZEA) and the trichocethenes nivalenol (NIV) and deoxynivalenol (DON). Table 1 shows the maximum levels allowed in Europe for these mycotoxins and for ochratoxin A (OTA) (full dataset is found in¹³⁻¹⁶).

TABLE 1
Maximum levels of mycotoxins allowed
in foodstuff and animal feed in Europe.

| | Max. in cereals | |
|---|---|---|
| | for human | Max. in cereals |
| | consumption | for animal feed |
| Toxin | (μg/kg) | (μg/kg) |
| Deoxynivalenol (DON) | 750 | 900 |
| Zearalenone (ZEA) | 75 | 100 |
| Ochratoxin A (OTA) | 3 | 50 |

Reducing the pH of BSG using an acid compound to no more than 4 pH units significantly inhibits the growth of total and aerobic mesophilic bacteria in BSG stored at 25° C. We find 10^{2.7} and 10² CFU total and mesophilic bacteria, respectively, per gram acidified BSG after 1 week storage at 25° C. More specifically, we find 10³ and 10^{2.1} CFU total and mesophilic bacteria, respectively, per gram of acidified BSG after 2 weeks storage at 25° C.

Reducing the pH of BSG using an acid compound to no more than 4 pH units significantly inhibits the growth of mold in BSG stored at 25° C. We find 10²-10^{2.4} CFU/g acidified BSG after 1 week storage at 25° C., and more specifically, less than 10² CFU/g acidified BSG after two weeks storage at 25° C.

The levels of mycotoxins monitored in acidified BSG after one week storage at 25° C. are correspondingly low: DON, not detected (detection threshold (DT)=20 μg/kg); NIV, not detected (DT=20 μg/kg); ZEA, not detected (DT=30 μg/kg) and; OTA, 0.6 μg/kg (DT=0.5 μg/kg).

Therefore, one object of this invention is to reduce the content of mycotoxins in brewers' spent grain (BSG) for animal or human consumption by minimizing the proliferation of mycotoxin-producing fungi by means of acidification of BSG.

In this invention, acidification of BSG results in a microbiologically stable BSG (MS-BSG) with the same protein, soluble fiber and insoluble fiber values as fresh BSG, with bacterial and fungal counts not higher than 10³ CFU/g after two weeks storage at 25° C., and with low or undetectable levels of mycotoxins after one week of storage at 25° C.

An additional object of this invention is to produce microbially stable BSG (MS-BSG) powder with organoleptical characteristics that are agreeable to consumers. In this invention, a mixture of acetic acid and lactic acid to a final concentration of 0.4% each are used as acidifying agents. Acetic acid is more volatile (vapor pressure=15.8 mm Hg at 20° C.) than lactic acid (0.0813 mm Hg at 20° C.). Acetic acid has a lower detection threshold (200 mg/L in beer) than lactic acid (400 mg/L in beer). At high concentrations, acetic acid has a pungent, vinegar-like aroma. We examined the impact of acetic acid concentration in MS-BSG on consumer acceptance of downstream beverage product made with MS-BSG. MS-BSG acidified with various acetic acid concentrations was used to produce a base for a fermented beverage. MS-BSG was milled, its pH brought up to 6.1 pH units, treated with saccharification enzymes and fermented with lactic acid bacteria. We found that levels of acetic acid higher than 0.4% in the starting MS-BSG resulted in consumer rejection of the fermented MS-BSG beverage and that a beverage made with MS-BSG stabilized with 0.4% lactic acid and no more than 0.4% acetic acid was accepted by a consumer panel.

### DETAILED DESCRIPTION OF THE INVENTION

Fresh brewers' spent grain (BSG) with a moisture content of 70% is retrieved from the wort filter or lauter tun. Fresh BSG is preferably processed no later than 8 hrs from release from the filter/lauter tun and are preferably collected by transferring the BSG from a mash separation unit to a collection tank by or through a BSG transfer line, wherein the acidification of the BSG is done during transfer of the BSG to the collection tank. Preferably, BSG is processed ‘in-line’ as it is conveyed from the filter/lauter tun to storage or transport vessels.

The present invention, amongst others, concerns the process of chemical acidification of BSG by addition of one or a combination of acid compounds to reduce the pH of BSG to a level not higher than 4.1 pH units, more specifically 3.85-3.95 pH units. Specifically, the process makes use of one or a combination of organic acids such as, but not limited to lactic acid, acetic acid, citric acid, benzoic acid, malic acid, formic acid or ascorbic acid to reduce the pH of BSG to a level not higher than 4.1 pH units, more specifically 3.85-3.95 pH units. Even more specifically, the process makes use of 0.4% food-grade acetic and 0.4% food-grade lactic acid to reduce the pH of BSG to a level not higher than 4.1 pH units, more specifically 3.85-3.95 pH units and to obtain a sensorially agreeable product.

It is the object of this invention to provide microbiologically stable BSG (MS-BSG) powder which is characterized by:
a pH level not higher than 4.1 pH units, more specifically 3.85-3.95 pH units
the same nutritional value as fresh BSG
after one week storage at 25° C., a colony count not higher than 10³ CFU/g MS-BSG total aerobic bacteria and; not higher than 10³ CFU/g MS-BSG fungi and; not higher than 10³ CFU/g MS-BSG yeast and; not higher than 10³ CFU/g MS-BSG mesophilic aerobic bacteria and; not higher than 10³ CFU/g MS-BSG total anaerobic bacteria
after one week storage at 25° C., mycotoxin levels not higher than 3 μg/kg Ochratoxin A (OTA), preferably not higher than 1 μg/kg OTA, even more preferably undetectable levels of OTA and; not higher than 750 μg/kg deoxynivalenol (DON), preferably not higher than 20 μg/kg DON, even more preferably undetectable levels of DON and; 20 μg/kg nivalenol (NIV), more preferably undetectable levels of nivalenol and; not higher than 75 μg/kg zearalenone (ZEA), preferably not higher than 30 μg/kg ZEA, and more preferably undetectable levels of ZEA

In one embodiment of this invention, fresh BSG is mixed with stock solutions of acetic acid and lactic acid, to a final concentration of 0.4% each, in storage vessels no later than 8 hrs after release from filters/lauter tun.

In the preferred embodiment of this invention, fresh BSG is mixed with stock solutions of acetic and lactic acid, to a final concentration of 0.4% each, ‘in-line’ as it is conveyed from filter/lauter tun to storage. This embodiment represents the most efficient application of the method here described.

In accordance with the present invention, the stabilized BSG (MS-BSG) is dried and further processed into a powder.

Different options are available for drying and powdering the MS-BSG. A first option comprises drying the MS-BSG, which is typically a slurry, by conventional drying methods such as freeze drying, lyophilization, heating, press-drying, vacuum evaporation, air drying or combinations of one or more of such techniques.

After drying, the MS-BSG can be processed into a powder by milling or cutting the dried matter into fine particles, preferably with a average mean particle size of below 1.4 mm, preferably ranging between 10 micron and 700 micron, more preferably between 250 and 650 micron.

Alternatively, the MS-BSG slurry is first separated into fractions by filtration or decanting to obtain a liquid phase (permeate) comprising salts, oligosaccharides, water soluble proteinaceous material and water soluble arabinoxylans; and a wet solid phase comprising amongst others precipitated proteins and water-insoluble arabinoxylans.

Both fractions can subsequently be dried independently from one another by conventional drying methods such as freeze drying, lyophilization, heating, press-drying, vacuum evaporation, air drying or combinations of one or more of such techniques. Also spray-drying can be used to dry and powderize the liquid phase in a single processing step. In this last case, further powdering or reduction of the powder particle size can be achieved by milling or mixing.

The two powderized streams can either be kept separate, ie. one powder originating from the permeate and one powder originating from the retentate or both powders can be blended/mixed together in a preferred ratio.

As prior to the drying and the powderization, the BSG material was microbiologically stabilized, the powder itself, if handled with due care according to HCCP standards, is microbiologically stable.

The above described microbiologically stable brewers' spent grain (MS-BSG) powder can be used in the following applications:
Animal feed. MS-BSG powder can be used as feed or feed complement for animals. More specifically, it can be used as feed or feed complement for ruminant cattle, such as dairy cows.
As human food or food ingredient. MS-BSG powder can be used as an ingredient in the manufacture of foods such as breads, cookies, cereal products, baked snacks, extrusion cooked snacks, candy bars or pasta products; and/or in the manufacture of food ingredients such as flours; and/or in the manufacture of dietary supplements such as fiber supplements.

The brewer's spent grain is preferably obtained from a regular beer production process, wherein malt and potentially some adjuncts such as corn, rice, sorghum, wheat, barley, rye, oat or combinations thereof are mixed with water to form a mash wherein enzymes—either originating from the barley malt or added separately to the mash—are allowed to break down starch into fermentable sugars, typically a mixture of glucose, maltose and maltotriose. At the end of the mashing, the mash is filtered to obtain a fermentable wort that is further processed in to beer. The retentate of the mash filtering is the brewer's spent grain (BSG) that is subsequently stabilized by a method described supra.

### REFERENCES

1. Mussatto, S. I., Dragone, G. & Roberto, I. C. Brewers' spent grain: Generation, characteristics and potential applications. J. Cereal Sci. 43, 1-14 (2006).
2. Xiros, C. & Christakopoulos, P. Biotechnological potential of brewers spent grain and its recent applications. Waste and Biomass Valorization 3, 213-232 (2012).
3. Lynch, K. M., Steffen, E. J. & Arendt, E. K. Brewers' spent grain: a review with an emphasis on food and health. J. Inst. Brew. 122, 553-568 (2016).
4. Robertson, J. A. et al. Profiling brewers' spent grain for composition and microbial ecology at the site of production. LWT—Food Sci. Technol. 43, 890-896 (2010).
5. Tang, Z., Cenkowski, S. & Izydorczyk, M. Thin-layer drying of spent grains in superheated steam. J. Food Eng. 67, 457-465 (2005).
6. Bartolomé, B., Santos, M., Jiménez, J. J., del Nozal, M. J. & Gómez-Cordovés, C. Pentoses and Hydroxycinnamic Acids in Brewer's Spent Grain. J. Cereal Sci. 36, 51-58 (2002).
7. EI-Shafey, E. I. et al. Dewatering of Brewer's Spent Grain Using a Membrane Filter Press: A Pilot Plant Study. Sep. Sci. Technol. 39, 3237-3261 (2004).
8. Al-Hadithi, A. N., Muhsen, A. A. & Yaser Baghdad (Iraq). Agriculture and Water Resources Research Centre), A. A. (Scientific R. C. A study on the possibility of using some organic acids as preservatives for brewer's by products. (1985).
9. Wang, B., Luo, Y., Myung, K. H. & Liu, J. X. Effects of storage duration and temperature on the chemical composition, microorganism density, and in vitro rumen fermentation of wet brewers grains. Asian-Australasian J. Anim. Sci. 27, 832-840 (2014).
10. Simas, M. M. S. et al. Determination of fungal microbiota and mycotoxins in brewers grain used in dairy cattle feeding in the State of Bahia, Brazil. Food Control 18, 404-408 (2007).
11. Pinotti, L., Ottoboni, M., Giromini, C., Dell'Orto, V. & Cheli, F. Mycotoxin contamination in the EU feed supply chain: A focus on Cereal Byproducts. Toxins (Basel). 8, (2016).
12. Food and Agriculture Organization of the United Nations & World Health Organization. Code of Practice for the Prevention and Reduction of Mycotoxin Contamination in Cereals. 1-11 (2014).
13. European Commision. COMMISSION REGULATION (EC) No 1883/2006 of 19 Dec. 2006 laying down methods of sampling and analysis for the official control of levels of dioxins and dioxin-like PCBs in certain foodstuffs (Text with EEA relevance). Off. J. Eur. Union 49, 5-24 (2006).
14. European Commission. 2013/165/EU: Commission Recommendation of 27 Mar. 2013 on the presence of T-2 and HT-2 toxin in cereals and cereal products Text with EEA relevance. Off. J. Eur. Union 56, 12-15 (2013).
15. European Commission. Commission Recommendation of 17 Aug. 2006 on the presence of deoxynivalenol, zearalenone, ochratoxin A, T-2 and HT-2 and fumonisins in products intended for animal feeding. Off. J. Eur. Union 49, 7-9 (2006).
16. The European Parliament and the Council of the European Union. Directive 2002/32/EC of the European Parliament and of the Council of 7 May 2002 on undesirable substances in animal feed. 1-30 (2002).

1-15. (canceled)

16. A process processing fresh brewer's spent grains (BSG), the process comprising the steps of:
producing a mash comprising barley malt;
separating the mash from BSG;
collecting the BSG;
microbiologically stabilizing the collected BSG to obtain a MS-BSG slurry; wherein said MS-BSG slurry is separated into a water soluble and water insoluble fraction by filtration or decanting to obtain a liquid phase (permeate) comprising salts, oligosaccharides, water soluble proteinaceous material and water soluble arabinoxylans; and a wet solid phase comprising precipitated proteins and water-insoluble arabinoxylans;
drying said fractions; and
powdering said fractions to a powder, wherein said powder has an average mean particle size of below 1.4 mm.

17. The process according to claim 16, wherein said powder has an average mean particle size of between 10 micron and 700 micron.

18. The process according to claim 16, wherein said drying and powdering occurs by spray-drying.

19. The process according to claim 16, comprising mixing or blending the dried water soluble and dried water insoluble fraction.

20. The process according to claim 16, the step of microbiologically stabilizing the collected BSG, comprising acidifying the BSG to a pH of 4 or lower, such that the BSG:
is acidified prior to reaching mycotoxin levels higher than 3 μg/kg Ochratoxin A (OTA), higher than 750 μg/kg deoxynivalenol (DON), higher than 20 μg/kg nivalenol (NIV), and higher than 75 μg/kg zearalenone (ZEA) and/or
having a colony count of not higher not higher than 103 CFU/g MS-BSG total aerobic bacteria and; not higher than 103 CFU/g MS-BSG fungi and; not higher than 103 CFU/g MS-BSG yeast and; not higher than 103 CFU/g MS-BSG mesophilic aerobic bacteria and; not higher than 103 CFU/g MS-BSG total anaerobic bacteria, after one week of storage at 25° C.

21. The process according to claim 20, wherein within a time frame of 8 hours after the separation of the mash from the BSG, acidifying the BSG to a pH of between 3.85-3.95.

22. The process according to claim 20, wherein acidification is achieved by the addition of one or more of the acids of the group comprising: lactic acid, acetic acid, benzoic acid, malic acid, formic acid and ascorbic acid.

23. The process according to claim 22, wherein acidification is achieved by the addition of 0.4% food-grade acetic acid and 0.4% food-grade lactic acid.

24. The process according to claim 16, wherein the BSG are collected by transferring the BSG from a mash separation unit to a collection tank by or through a BSG transfer line, and wherein the acidification of the BSG is done during transfer of the BSG to the collection tank.

25. Microbiologically stable brewers' spent grains (MS-BSG) powder enriched for water-soluble arabinoxylans derived from said BSG, said powder having a colony count of not higher than 103 CFU/g MS-BSG counts of aerobic bacteria, fungi, yeast, mesophilic aerobic and anaerobic bacteria, after one week of storage at 25° C., characterized in that the mean average particle size of said powder is below 1.4 mm.

26. Microbiologically stable brewers' spent grains (MS-BSG) powder enriched for water-insoluble arabinoxylans derived from said BSG, said powder having a colony count of not higher than 103 CFU/g MS-BSG counts of aerobic bacteria, fungi, yeast, mesophilic aerobic and anaerobic bacteria, after one week of storage at 25° C., characterized in that the mean average particle size of said powder is below 1.4 mm.

27. Microbiologically stable brewers' spent grains powder according to claim 25, characterized in that the mean average particle size of said powder is between 10 micron and 700 micron.

28. Microbiologically stable brewers' spent grains powder according to claim 25, having mycotoxin levels not higher than 3 μg/kg Ochratoxin A (OTA), not higher than 750 μg/kg deoxynivalenol (DON), not higher than 20 μg/kg nivalenol (NIV), and not higher than 75 μg/kg zearalenone (ZEA).

29. Microbiologically stable brewers' spent grains powder according to claim 25, obtained by a process comprising the steps of:
producing a mash comprising barley malt;
separating the mash from BSG;
collecting the BSG;
microbiologically stabilizing the collected BSG to obtain a MS-BSG slurry; wherein said MS-BSG slurry is separated into a water soluble and water insoluble fraction by filtration or decanting to obtain a liquid phase (permeate) comprising salts, oligosaccharides, water soluble proteinaceous material and water soluble arabinoxylans; and a wet solid phase comprising precipitated proteins and water-insoluble arabinoxylans;
drying said fractions; and
powdering said fractions to a powder, wherein said powder has an average mean particle size of below 1.4 mm.

30. A bakery product, candy bar or beverage comprising the microbiologically stable brewers' spent grains (MS-BSG) according to claim 25.
